(19) United States
(12) Patent Application Publication
(10) Pub. No.: US 2016/0071656 A1
(43) Pub. Date: Mar. 10, 2016

(54) PHOTOELECTRIC CONVERSION ELEMENT

(71) Applicant: Panasonic Corporation, Osaka (JP)

(72) Inventors: HIROKI YABE, Osaka (JP); MICHIO SUZUKA, Osaka (JP); NAOKI HAYASHI, Osaka (JP); TAKASHI SEKIGUCHI, Osaka (JP)

(21) Appl. No.: 14/813,119

(22) Filed: Jul. 30, 2015

(30) Foreign Application Priority Data
Sep. 5, 2014 (JP) 2014-181386

(51) Int. Cl. H01G 9/20

(52) U.S. Cl. CPC H01G 9/2031; H01G 9/2018; H01G 9/2022

(57) ABSTRACT

The techniques disclosed here feature a photoelectric conversion element. The photoelectric conversion element comprises a photoanode, a counter electrode, and an electrolytic medium located between the photoanode and the counter electrode. The photoanode includes a porous semiconductor layer and dye molecules located on the porous semiconductor layer. The porous semiconductor layer includes a light-scattering layer. The electrolytic medium contains a redox reagent. The light-scattering layer includes macropores having a pore diameter of 50 nm or more. The macropores having an arithmetic mean pore diameter of 0.5 μm or more and 10 μm or less. The redox reagent has a maximum molar absorption coefficient ε of 3000 L·cm⁻¹·mol⁻¹ or less within wavelengths of 380 nm to 800 nm.

### BACKGROUND

1. Technical Field

The present disclosure relates to photosensitized photoelectric conversion elements. The photosensitized photoelectric conversion elements include what are called dye-sensitized solar cells. The photosensitized photoelectric conversion elements also include photoelectrochemical power generation elements with which electric power can be generated even under relatively low-illuminance conditions, such as the indoors.

2. Description of the Related Art

Dye-sensitized solar cells, i.e., solar cells in which a dye is used as a photosensitizer, have been under active research and development in recent years. A dye-sensitized solar cell typically has a photoanode, a counter electrode, and an electrolytic medium between the photoanode and the counter electrode. The photoanode is composed of, for example, a transparent electroconductive film, a porous semiconductor layer on the transparent electroconductive film, and a dye held on the surface of the porous semiconductor layer. The electrolytic medium is, for example, an electrolytic solution containing a redox reagent (mediator).

For better characteristics of dye-sensitized solar cells, it is needed to improve the characteristics of their individual components. For example, the porous semiconductor layer of a dye-sensitized solar cell described in Ito, S., et al., Adv. Matter, 18, 1202-1205 (2006) has a nanocrystalline titanium oxide layer and a light-scattering layer on the nanocrystalline titanium oxide layer. The light-scattering layer is composed of particles of anatase titanium oxide having a mean diameter of 400 nm. Such a bilayer structure of the porous semiconductor layer allows light to pass through the nanocrystalline titanium oxide layer and scatters it in the light-scattering layer. The scattered light is used for photoelectric conversion in the nanocrystalline titanium oxide layer, making the photoelectric conversion process more efficient.

Japanese Unexamined Patent Application Publication No. 2001-76772 discloses a dye-sensitized solar cell that has a porous semiconductor layer containing hollow particles. The hollow particles have a shell made up of fine particles of a metal oxide. According to the publication, the use of hollow particles having a mean diameter similar to a wavelength of light that contributes to photoelectric conversion (200 nm to 10 μm) makes light more effectively scattered in and confined to the porous semiconductor layer, leading to more efficient use of the light. The publication also discloses an emulsion polymerization-based method for forming the hollow particles.

The photoelectrode of a dye-sensitized solar cell described in Japanese Patent No. 5389372 has a porous light-absorbing layer and a porous light-scattering layer on the porous light-absorbing layer. The porous light-absorbing layer is composed of nanoparticles of a metal oxide. The porous light-scattering layer is composed of aggregates of nanoparticles of a metal oxide. Each aggregate of nanoparticles of a metal oxide is a hollow sphere (a mean diameter of 100 nm to 5 μm), with the nanoparticles of a metal oxide forming a shell. According to the publication, the hollow-sphere aggregates of nanoparticles of a metal oxide are capable of generating photoelectrons because of their ability to adsorb dyes. Furthermore, a light-scattering effect of the hollow-sphere aggregates of nanoparticles of a metal oxide improves the efficiency of energy conversion. These hollow-sphere aggregates of nanoparticles of a metal oxide are formed through a chemical reaction in which a solution of titanium isopropoxide in ethanol is used.

In all of the aforementioned article and patent publications, iodine compounds are the only disclosed redox reagents that can be used in the dye-sensitized solar cell.

### SUMMARY

One non-limiting and exemplary embodiment provides a photoelectric conversion element of high conversion efficiency.

In one general aspect, the techniques disclosed here feature a photoelectric conversion element. The photoelectric conversion element comprises a photoanode, a counter electrode, and an electrolytic medium located between the photoanode and the counter electrode. The photoanode includes a porous semiconductor layer and dye molecules located on the porous semiconductor layer. The porous semiconductor layer includes a light-scattering layer. The electrolytic medium contains a redox reagent. The light-scattering layer includes macropores having a pore diameter of 50 nm or more. The macropores having an arithmetic mean pore diameter of 0.5 μm or more and 10 μm or less. The redox reagent has a maximum molar absorption coefficient ε of 3000 L·cm⁻¹·mol⁻¹ or less within wavelengths of 380 nm to 800 nm.

It should be noted that general or specific embodiments may be implemented as an element, a device, a system, an integrated circuit, a method, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view of the structure of a photoelectric conversion element 100 according to an embodiment of the present disclosure; and

FIG. 2 is a cross-sectional SEM image of a porous semiconductor layer in a photoelectric conversion element according to an Example.

### DETAILED DESCRIPTION

Achieving high conversion efficiency with the dye-sensitized solar cell described in Ito's article requires increasing the thickness of the nanocrystalline titanium oxide layer. This makes it more likely that reverse electronic reaction, i.e., the movement of electrons to the electrolytic medium, occurs on the surface of the particles of nanocrystalline titanium oxide. As a result, the open-circuit voltage V_{oc} of the photoelectric conversion element drops. Thinning the nanocrystalline titanium oxide layer to prevent this drop in open-circuit voltage, however, causes the light that is scattered in the light-scattering layer and returned into the nanocrystalline titanium oxide layer to leak out of the element without sufficient absorption in the nanocrystalline titanium oxide layer. This makes the generation of photoelectrons less efficient. It is therefore difficult to combine a high open-circuit voltage, which is needed to achieve high conversion efficiency, and efficient generation of photoelectrons in the dye-sensitized solar cell described in Ito's paper.

The hollow-particle and hollow-sphere structures described in the two patent publications are disadvantageous in that they are unsuitable for mass production.

The present disclosure includes the photoelectric conversion elements, method for producing a photoelectric conversion element, and liquid dispersion for forming a porous electrode according to the following items.

### Item 1

A photoelectric conversion element, comprising: a photoanode including a porous semiconductor layer and dye molecules located on the porous semiconductor layer, the porous semiconductor layer including a light-scattering layer; a counter electrode; and an electrolytic medium located between the photoanode and the counter electrode, the electrolytic medium containing a redox reagent, wherein: the light-scattering layer has macropores having a pore diameter of 50 nm or more, the macropores having an arithmetic mean pore diameter of 0.5 μm or more and 10 μm or less; and the redox reagent has a maximum molar absorption coefficient ε of 3000 L·cm⁻¹·mol⁻¹ or less within wavelengths of 380 nm to 800 nm.

### Item 2

The photoelectric conversion element according to Item 1, wherein a part of the electrolytic medium is present in the macropores.

### Item 3

The photoelectric conversion element according to Item 1 or 2, wherein at least two of the macropores are connected to each other.

### Item 4

The photoelectric conversion element according to any one of Items 1 to 3, wherein at least one of the macropores has an opening in a surface of the light-scattering layer.

### Item 5

The photoelectric conversion element according to any one of Items 1 to 4, wherein the light-scattering layer has a thickness of 3 μm or more and 15 μm or less.

### Item 6

The photoelectric conversion element according to any one of Items 1 to 5, wherein: the porous semiconductor layer further includes a low-light-scattering layer located on a light incident side of the light-scattering layer, the low-light-scattering layer scattering light less than the light-scattering layer does or not scattering light; and the low-light-scattering layer has a thickness of less than 1.5 μm.

### Item 7

The photoelectric conversion element according to any one of Items 1 to 6, wherein the redox reagent includes a nitroxyl radical-bearing compound.

### Item 8

The photoelectric conversion element according to Item 7, wherein the nitroxyl radical-bearing compound is TEMPO, 4-hydroxy-2,2,6,6-tetramethylpiperidine-1-oxyl.

### Item 9

A method for producing the photoelectric conversion element according to any one of Items 1 to 8, the method comprising forming the porous semiconductor layer using a liquid dispersion. The liquid dispersion contains a mixture of water and a hydrophilic organic medium, thermally decomposable polymer particles having an arithmetic mean diameter of 0.5 μm or more and 10 μm or less and insoluble in the mixture, a thermally decomposable polymer soluble in the mixture, and semiconductor nanoparticles having an arithmetic mean diameter of 10 nm or more and 50 nm or less. The soluble polymer is a copolymer containing a hydrophilic block and a hydrophobic block.

### Item 10

A liquid dispersion for forming a porous electrode, the liquid dispersion comprising a mixture of water and a hydrophilic organic medium, thermally decomposable polymer particles having an arithmetic mean diameter of 0.5 μm or more and 10 μm or less and insoluble in the mixture, a thermally decomposable polymer soluble in the mixture, and semiconductor nanoparticles having an arithmetic mean diameter of 10 nm or more and 50 nm or less, wherein the soluble polymer is a copolymer containing a hydrophilic block and a hydrophobic block.

### Embodiments

The following describes some embodiments of the present disclosure with reference to the drawings.

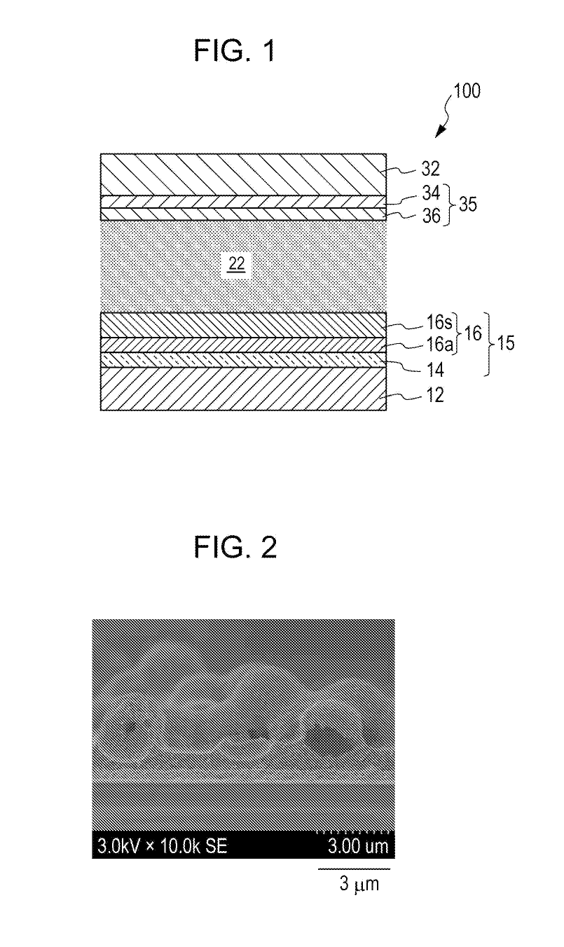

FIG. 1 is a schematic view of the structure of a photoelectric conversion element 100 according to an embodiment of the present disclosure. The photoelectric conversion element 100 has a photoanode 15, a counter electrode 35, and an electrolytic medium 22 between the photoanode 15 and the counter electrode 35. The electrolytic medium 22 is typically an electrolytic solution containing a redox reagent and hereinafter may be referred to as the electrolytic solution 22. Besides an electrolytic solution, the electrolytic medium 22 can be, for example, an electrolytic gel or solid polymer electrolyte containing a redox reagent.

The photoanode 15 is supported on a substrate 12. The photoanode 15 has, for example, an electroconductive layer 14 permeable to visible light and a porous semiconductor layer 16 on the electroconductive layer 14. The electroconductive layer 14 may also be referred to as “the transparent electroconductive layer.” The porous semiconductor layer 16 has a semiconductor and dye molecules, which serve as a photosensitizer, held on the surface of the semiconductor. The porous semiconductor layer 16 may be referred to simply as the semiconductor layer 16.

The semiconductor layer 16 has a light-scattering layer 16s. The light-scattering layer 16s has macropores having a pore diameter of 50 nm or more. The arithmetic mean pore diameter of the macropores is 0.5 μm or more and 10 μm or less. As described through the presentation of Examples hereinafter, it is desirable that the thickness of the light-scattering layer 16s be 3 μm or more and 15 μm or less.

It is desirable that the semiconductor layer 16 further have a low-light-scattering layer 16a. It is desirable that the low-light-scattering layer 16a be closer to the light-receiving side than the light-scattering layer 16s is. Furthermore, it is desirable that the low-light-scattering layer 16a scatter light less than the light-scattering layer 16s does. The low-light-scattering layer 16a may not scatter light. It is desirable that the thickness of the low-light-scattering layer 16a be 1.5 μm or less. The low-light-scattering layer 16a is, for example, a porous layer composed of semiconductor nanoparticles.

The light-scattering layer 16s is also composed of semiconductor nanoparticles. The light-scattering layer 16s has voids larger than those in the low-light-scattering layer 16a. This provides the light-scattering layer 16s light-scattering properties stronger than those of the low-light-scattering layer 16a. The voids with pore diameters of 50 nm or more the light-scattering layer 16s has are herein referred to as macropores. The semiconductor nanoparticles making up the light-scattering layer 16s can be of the same kind as those making up the low-light-scattering layer 16a. The light-scattering layer 16s and the low-light-scattering layer 16a, which are both porous, have a large specific surface area. The light-scattering layer 16s and the low-light-scattering layer 16a therefore accommodate a large number of dye molecules. Titanium oxide, compared with other semiconductors, has high photoelectric conversion properties and is unlikely to dissolve in electrolytic solution upon exposure to light. Thus, nanoparticles of titanium oxide are suitable for use as the semiconductor nanoparticles.

Furthermore, the light-scattering layer 16s can be easily formed using a liquid dispersion containing thermally decomposable polymer particles insoluble or sparingly soluble in a solvent, a thermally decomposable polymer soluble in the solvent, and semiconductor nanoparticles. The arithmetic mean diameter of the polymer particles is, for example, 0.5 μm or more and 10 μm or less. The arithmetic mean diameter of the semiconductor nanoparticles is, for example, 10 nm or more and 50 nm or less. The light-scattering layer in this disclosure is exemplified by the light-scattering layer 16s in the present embodiment. The low-light-scattering layer in this disclosure is exemplified by the low-light-scattering layer 16a in the present embodiment.

The counter electrode 35 faces the semiconductor layer 16 via the electrolytic medium 22. The counter electrode 35 is supported on a substrate 32 and has, for example, an electroconductive oxide layer 34 and a metal layer (e.g., a platinum layer) 36 on the electroconductive oxide layer 34.

The electrolytic medium 22 is, for example, an electrolytic solution containing a redox reagent and is sealed between the photoanode 15 and the counter electrode 35 by a sealer not illustrated.

It is desirable that this electrolytic medium 22 be in the macropores existing in the semiconductor layer 16. Furthermore, it is desirable that the dye molecules be also adsorbed in the macropores. This makes the photoelectric conversion process more efficient by ensuring that the generation of charge induced by light absorption also occurs on the inner surfaces of the macropores. Furthermore, the pathways formed by the macropores, through which the redox reagent can diffuse, accelerate the diffusion of the redox reagent in the semiconductor layer 16.

In the photoelectric conversion element 100 according to the present embodiment, the redox reagent has a low molar absorption coefficient for visible wavelengths. Because of the low absorption of light by the redox reagent in the macropores, the presence of the electrolytic medium 22 in the macropores existing in the semiconductor layer 16 does not interfere with the absorption of light by the dye molecules.

A specific example of a desirable method for introducing the electrolytic medium 22 into the macropores is to place the semiconductor layer 16 under reduced pressure or the electrolytic medium 22 under increased pressure while loading the electrolytic medium 22. It would be more desirable to bring the semiconductor layer 16 into contact with the electrolytic medium 22 under reduced pressure and then slowly return the pressure to normal. Such a method is generally referred to as vacuum impregnation or low-pressure impregnation.

In the aforementioned two patent publications, Japanese Unexamined Patent Application Publication No. 2001-76772 and Japanese Patent No. 5389372, the electrolytic medium appears not to be in the macropores in the hollow particles, as judged from the process used to produce the light-scattering layer. The first step described in these publications is to produce hollow particles through firing. These hollow particles are applied to form a film, which is then fired to form a scattering layer. The fine particles making up the shell of the hollow particles are therefore fired twice. The spaces between the shell-forming fine particles should thus be very small because of promoted integration of the fine particles. These patent publications, furthermore, do not mention any method like the above, which would make the electrolytic medium penetrate into the macropores.

It is desirable that the structure of the semiconductor layer 16 be such that its light-scattering properties are low on the light-receiving side and increase along the direction of the travel of light (e.g., a multilayer structure), rather than a monolayer structure uniform in the direction of thickness. Such a structure, increasing the efficiency of light absorption, provides a photoelectric conversion element with high conversion efficiency (e.g., see Japanese Unexamined Patent Application Publication Nos. 2010-272530 and 2002-289274). A porous semiconductor layer having high light-scattering properties may herein be referred to as a light-scattering layer.

The semiconductor layer 16 of the photoelectric conversion element 100 according to the present embodiment has a light-scattering layer 16s. The following describes the light-scattering layer 16s in detail. The arithmetic mean pore diameter of macropores mentioned in this application is determined from the pore distribution obtained with mercury intrusion. That is, the arithmetic mean pore diameter of macropores mentioned in this application is a volume arithmetic mean pore diameter. Actually the arithmetic mean pore diameter of macropores is substantially equal to the peak diameter in the pore distribution. The arithmetic mean pore diameter of macropores may be determined with nitrogen adsorption (the BJH analysis) or a scanning electron microscope.

The light-scattering layer 16s has macropores with an arithmetic mean pore diameter of 0.5 μm or more and 10 μm or less, desirably 1.5 μm or more and 8 μm or less. Reducing the arithmetic mean pore diameter of the macropores to less than 0.5 μm makes light scattering less likely. Increasing the arithmetic mean pore diameter of the macropores to more than 10 μm may cause too few interfaces in the light-scattering layer 16s to be available for light scattering.

It is desirable that the thickness of the light-scattering layer 16s be 3 μm or more and 15 μm or less, more desirably 4 μm or more and 10 μm or less. Reducing the thickness of this layer to less than 3 μm may cause both scattering and absorption of light to be insufficient. Increasing the thickness of this layer to more than 15 μm may result in the failure to enhance the conversion efficiency because of an increased drop in the open-circuit voltage V_{oc} of the photoelectric conversion element 100 associated with a decrease in the electron density in the semiconductor layer 16.

It is desirable that the macropores in the light-scattering layer 16s be spherical. This is because the macropores are formed using water-insoluble polymer particles (described hereinafter), and it is easy to obtain these particles in the form of spheres.

The macropores in the light-scattering layer 16s may be button-shaped. A button shape allows more pores to be present than in the case where, for example, the macropores are spherical. The use of button-shaped macropores therefore leads to an increased number of light-scattering interfaces. The sides of the button shape may be flat, curved, or uneven, examples including a hemisphere and a convex lens.

It is desirable that at least two of the macropores in the light-scattering layer 16s be connected to each other. Such a structure helps to introduce the electrolytic medium 22 into the macropores. It is desirable that the connected macropores have an opening to the outside. This further helps to introduce the electrolytic medium 22 into the macropores. The macropores may be in the form of a chain of multiple spherical or button-shaped pores.

It is desirable that the light-scattering layer 16s have a large surface roughness. It is desirable that the surface roughness factor of the light-scattering layer 16s, given as the effective area divided by the projected area, be 10 or more, more desirably 100 or more. The effective area represents an effective surface area calculated from the volume of the light-scattering layer 16s (determined from the projected area and the thickness) and the specific surface area and bulk density of the material making up the light-scattering layer 16s.

On the outermost surface of the light-scattering layer 16s, macropores need not be closed and may be exposed. In other words, at least one of the multiple macropores may have an opening in the surface of the light-scattering layer 16s. This makes it easier to introduce the electrolytic medium 22 into the macropores. The outermost surface of the light-scattering layer 16s may have an uneven structure that conforms to the curves, depressions, or other shapes formed by the macropores.

The light-scattering layer 16s according to the present embodiment reflects incident light little and scatters a large component of the light backwards. Thus, it is desirable that the structure of the light-scattering layer 16s be such that sufficient photoelectric conversion can be performed therein.

The light-scattering layer 16s may have small pores that occur when semiconductor nanoparticles aggregate or connect together. Such small pores are referred to as nanopores. It is desirable that the arithmetic mean pore diameter of the nanopores be 10 nm more and 50 nm or less. Reducing the arithmetic mean pore diameter of the nanopores to less than 10 nm causes the diffusion of the redox reagent into the porous electrode to be slow. Increasing the arithmetic mean pore diameter of the nanopores to more than 50 nm may causes the connections between semiconductor particles to be weak, so the resulting film may be weak.

It is desirable that the light-scattering layer 16s be composed of chains or aggregates of semiconductor nanoparticles. It is desirable that the arithmetic mean diameter of the semiconductor nanoparticles be 10 nm or more and 50 nm or less. Reducing the arithmetic mean diameter of the semiconductor nanoparticles to less than 10 nm makes it difficult to ensure that the arithmetic mean pore diameter of nanopores formed through the connection of multiple semiconductor nanoparticles reaches 10 nm. Increasing the arithmetic mean diameter of the semiconductor nanoparticles to more than 50 nm causes the specific surface area of the particles to be small, so the improvement of the efficiency of photoelectric conversion may be insufficient.

In order to obtain both sufficiently high light-scattering properties and film strength, it would be desirable that the porosity of the light-scattering layer 16s (the total volume of pores divided by the total volume of pores and the semiconductor) be 70% or more and 95% or less.

It is desirable that the porous semiconductor layer 16 according to the present embodiment have, in addition to the light-scattering layer 16s, a low-light-scattering layer 16a with low light-scattering properties. The low-light-scattering layer 16a is closer to the light-receiving side than the light-scattering layer 16s is, typically located on the substrate 12 side. Part of light that enters from the substrate 12 side is optically absorbed by the dye molecules in the low-light-scattering layer 16a. After passing through the low-light-scattering layer 16a, the light is optically absorbed by the dye molecules in the light-scattering layer 16s and scattered in the light-scattering layer 16s. The scattered light is optically absorbed by the dye molecules in the light-scattering layer 16s or the low-light-scattering layer 16a.

It is desirable that the low-light-scattering layer 16a have nanopores with an arithmetic mean pore diameter of 10 nm or more and 50 nm or less. Reducing the arithmetic mean pore diameter of the nanopores to less than 10 nm causes the diffusion of the redox reagent into the porous electrode to be slow. Increasing the arithmetic mean pore diameter of the nanopores to more than 50 nm may cause the connections between semiconductor particles to be weak, so the resulting film may be weak.

It is desirable that the low-light-scattering layer 16a be composed of chains or aggregates of semiconductor nanoparticles. It is desirable that the arithmetic mean diameter of the semiconductor nanoparticles be 10 nm or more and 50 nm or less. Reducing the arithmetic mean diameter of the semiconductor nanoparticles to less than 10 nm makes it difficult to ensure that the arithmetic mean pore diameter of nanopores formed through the connection of multiple semiconductor nanoparticles reaches 10 nm. Increasing the arithmetic mean diameter of the semiconductor nanoparticles to 50 nm or more may cause the specific surface area of the particles to be small, so the improvement of the efficiency of photoelectric conversion may be insufficient.

In order to obtain both the penetration of the electrolytic solution and film strength, it would be desirable that the porosity of the low-light-scattering layer 16a (the total volume of pores divided by the total volume of pores and semiconductor) be 50% or more and 70% or less.

As is widely known, the electron density in a semiconductor layer 16 is determined by the following equation.

Electron density (C/cm³)=(Quantity of charge in the semiconductor layer)/(Volume of the semiconductor layer)

As is clear from this equation, the electron density in a semiconductor layer 16 increases with decreasing volume of the semiconductor in the semiconductor layer 16. Furthermore, it is known that the open-circuit voltage of a photoelectric conversion element increases with increasing electron density in its semiconductor layer 16. A small thickness of the semiconductor layer therefore leads to a high open-circuit voltage. When the semiconductor layer 16 has a low-light-scattering layer 16a, a change in electron density has more impact on the low-light-scattering layer 16a, in which the semiconductor material is dense, than on the light-scattering layer 16s, in which the porosity is high because of macropores. It is desirable, in order for the open-circuit voltage to be high, that the thickness of the low-light-scattering layer 16a be not more than 1.5 μm, more desirably 1 μm or less.

The semiconductor layer 16 can be made of TiO₂, but the following inorganic semiconductors can also be used: oxides of metallic elements such as Cd, Zn, In, Pb, Mo, W, Sb, Bi, Cu, Hg, Ti, Ag, Mn, Fe, V, Sn, Zr, Sr, Ga, Si, and Cr; perovskites such as SrTiO₃ and CaTiO₃; sulfides such as CdS, ZnS, In₂S₃, PbS, Mo₂S, WS₂, Sb₂S₃, Bi₂S₃, ZnCdS₂, and Cu₂S; metal chalcogenides such as CdSe, In₂Se₃, WSe₂, HgS, PbSe, and CdTe; and other semiconductors such as GaAs, Si, Se, Cd₂P₃, Zn₂P₃, InP, AgBr, PbI₂, HgI₂, and BiI₃. In particular, CdS, ZnS, In₂S₃, PbS, Mo₂S, WS₂, Sb₂S₃, Bi₂S₃, ZnCdS₂, Cu₂S, InP, Cu₂O, CuO, and CdSe are advantageously capable of absorbing light with wavelengths of approximately 350 nm to 1300 nm. Composite semiconductors containing at least one of the semiconductors mentioned above can also be used, including CdS/TiO₂, CdS/AgI, Ag₂S/AgI, CdS/ZnO, CdS/HgS, CdS/PbS, ZnO/ZnS, ZnO/ZnSe, CdS/HgS, CdSₓ/CdSe₁₋ₓ, CdSₓ/Te₁₋ₓ, CdSeₓ/Te₁₋ₓ, ZnS/CdSe, ZnSe/CdSe, CdS/ZnS, TiO₂/Cd₃P₂, CdS/CdSeCd_{y}Zn_{1-y}S, and CdS/HgS/CdS.

Various methods can be used to form the semiconductor layer 16. For example, applying a mixture of a powder of a semiconductor material and an organic binder (containing an organic solvent) to an electroconductive layer and then removing the organic binder through heating produces a semiconductor layer made of an inorganic semiconductor.

In particular, the light-scattering layer can be easily formed using a liquid dispersion containing thermally decomposable polymer particles insoluble or sparingly soluble in a solvent (hereinafter also referred to as “insoluble polymer particles” for simplicity), a thermally decomposable polymer soluble in the solvent (hereinafter also referred to as “soluble polymer” for simplicity), and semiconductor nanoparticles. The arithmetic mean diameter of the polymer particles can be 0.5 μm or more and 10 μm or less. The arithmetic mean diameter of the semiconductor nanoparticles can be 10 nm or more and 50 nm or less. The liquid dispersion is applied to form a film, and this film is heated (or “fired”). As a result, the insoluble polymer particles decompose and disappear, leaving macropores in the light-scattering layer 16s.

The solvent is a mixture of water and a hydrophilic organic solvent. This means that the insoluble polymer is a water-insoluble polymer, and the soluble polymer is generally a water-soluble polymer. In the following description, the terms “water-insoluble polymer” and “water-soluble polymer” may be used for simplicity.

The liquid dispersion for the formation of the light-scattering layer 16s can be obtained through, for example, the mixing of thermally decomposable water-insoluble polymer particles, a thermally decomposable water-soluble polymer, and semiconductor nanoparticles in a mixture of water and a hydrophilic organic solvent. It is desirable that the arithmetic mean diameter of the water-insoluble polymer particles be more than 0.5 μm and less than 10 μm. It is desirable that the arithmetic mean diameter of the semiconductor nanoparticles be 10 nm or more and 50 nm or less. It is desirable that the water-soluble polymer be a block copolymer having a hydrophilic block and a hydrophobic block.

The thermally decomposable water-insoluble polymer particles can be of any kind. For example, it is possible to use at least one selected from polyolefins, butyl rubber, ethylene-vinyl acetate copolymers, ethylene-α-olefin copolymers, ethylene-methyl acrylate copolymers, ethylene-ethyl acrylate copolymers, ethylene-acrylic acid copolymers, ethylene-methacrylic acid copolymers, polyethylene, acrylic polymers, and ionomeric polymers, polystyrene-based, polyolefin-based, polydiene-based, polyester-based, polyurethane-based, fluorocarbon-based, and polyamide-based elastomers, methacrylic acid-based polymers, methacrylic acid-styrene copolymers, vinyl benzene-based polymers, and so forth.

The water-insoluble polymer particles can be in any shape, examples including a sphere and a button shape. The sides of the button shape may be flat, curved, or uneven, examples including a hemisphere and a convex lens.

It is desirable that the temperature at which the water-insoluble polymer particles disappear (disappearance temperature) be lower than the sintering temperature of the semiconductor nanoparticles. If the semiconductor nanoparticles are made of TiO₂, it is desirable that the disappearance temperature be 450° C. or less. If the formation of the light-scattering layer 16s includes firing, a disappearance temperature of more than 450° C. can make it likely that water-insoluble polymer particles residue remains after firing or lead to a low specific surface area of the semiconductor layer 16 because of oversintering of TiO₂. The disappearance temperature and water-insoluble polymer particles residue can be measured using thermogravimetric analysis (TG/DTA).

It is desirable that the thermally decomposable water-soluble polymer be a block copolymer having a hydrophilic block and a hydrophobic block.

A block copolymer is a molecule resulting from chemical bonding of polymers with different properties. Specific examples of block copolymers include triblock copolymers represented by R₁O—(R₂O)ₛ—(R₃O)ₜ—(R₄O)ᵤ—R₅ and diblock copolymers represented by R₁O—(R₂O)ₛ—(R₄O)ᵤ—R₅, where R₁ and R₅ denote H or a lower alkylene group having 1 to 6 carbon atoms, R₂, R₃, and R₄ denote a lower alkylene group having 2 to 6 carbon atoms, and s, t, and u denote a number of 2 to 200. Examples of other block copolymers that can be applied include block copolymers composed of polyethylene oxide (PEO) as a hydrophilic block and polystyrene (PS) or polyisoprene (PI) as a hydrophobic block. Such block copolymers include triblock copolymers PEO-PS (or PI)-PEO and diblock copolymers PEO-PS (or PI). The degree of polymerization of the PEO block is represented by 2 to 200, and that of the PS (or PI) block is represented by 2 to 50. In particular, HO—(C₂H₄O)₁₀₆—(C₃H₆O)₇₀—(C₂H₄O)₁₀₆—H is desirable.

As with the water-insoluble polymer particles, it is desirable that the water-soluble polymer disappear at a temperature lower than the sintering temperature of the semiconductor nanoparticles. If the semiconductor nanoparticles are made of TiO₂, it is desirable that the disappearance temperature be 450° C. or less. If the formation of the light-scattering layer 16s includes firing, a disappearance temperature of more than 450° C. can make it likely that water-soluble polymer residue remains after firing or lead to a low specific surface area of the semiconductor layer 16 because of oversintering of TiO₂. The disappearance temperature and water-soluble polymer residue can be measured using thermogravimetric analysis (TG/DTA).

It is desirable that the proportions by dry volume of the semiconductor nanoparticles and the water-insoluble polymer particles be in the range of 1:0.5 to 1:20, more desirably 1:1 to 1:10.

It is desirable that the proportions by dry volume of the semiconductor nanoparticles and the water-soluble polymer be in the range of 1:0.5 to 1:20, more desirably 1:2 to 1:10.

Examples of water-soluble organic solvents include water-soluble alcohols, ethers, ketones, aldehydes, nitriles, formamides, amines, pyridines, and pyrrolidones. In particular, water-soluble alcohols are desirable, more desirably lower alcohols having 1 to 3 carbon atoms.

Water and the water-soluble organic solvent may be mixed in any proportions unless phase separation occurs. In order for the dispersibility of the semiconductor nanoparticles and the solubility of the water-soluble polymer to be maintained, it would be desirable that water and the water-soluble organic solvent be mixed in proportions by volume of 1:0.3 to 1:100.

Various known coating or printing processes can be used to apply the liquid mixture to a substrate. Examples of coating processes include doctor blade coating, bar coating, spraying, dip coating, and spin coating, and examples of printing processes include screen printing.

### Counter Electrode

The counter electrode 35 serves as the cathode of the photoelectric conversion element 100. Examples of materials for the counter electrode 35 include metals such as platinum, gold, silver, copper, aluminum, rhodium, and indium, carbon materials such as graphite, carbon nanotubes, and platinum on carbon, electroconductive metal oxides such as indium-tin composite oxide, antimony-doped tin oxide, and fluorine-doped tin oxide, and electroconductive polymers such as polyethylenedioxythiophene, polypyrrole, and polyaniline. In particular, materials such as platinum, graphite, and polyethylenedioxythiophene are desirable.

As illustrated in FIG. 1, the counter electrode 35 may have a transparent electroconductive layer 34 on the substrate 32 side. The transparent electroconductive layer 34 can be made of the same material as the electroconductive layer 14 of the photoanode 15. In this situation, it is desirable that the counter electrode 35 also be transparent. If the counter electrode 35 is transparent, light can be received on the substrate 32 side or the substrate 12 side. This is effective if it is expected that the photoelectric conversion element 100 will be irradiated with light on both of its front and back sides because of the effects of reflected light or similar.

### Electrolytic Medium

The electrolytic medium 22 can be an electrolytic solution of a redox reagent (mediator) in a solvent, and can also be an electrolytic gel or polymer containing a redox reagent. The electrolytic medium is typically an electrolytic solution, desirably one containing a redox reagent, a solvent, and a supporting electrolyte.

It is desirable that the redox reagent in the electrolytic medium 22 have a maximum molar absorption coefficient ε of 3000 L·cm⁻¹·mol⁻¹ or less, more desirably 1000 L·cm⁻¹·mol⁻¹ or less, even more desirably 500 L·cm⁻¹·mol⁻¹ or less, within wavelengths of 380 nm to 800 nm. Reducing the molar absorption coefficient of the redox reagent prevents the absorption of light by the redox reagent, which does not contribute to photoelectric conversion.

Examples of desirable redox reagents that have a low maximum molar absorption coefficient within wavelengths of 380 nm to 800 nm include ferrocene, biphenyl, phenothiazine, and nitroxyl radical-bearing compounds. Nitroxyl radical-bearing compounds are particularly desirable. The nitroxyl radical, represented by chemical formula [I], is a compound that has the potential for repeated stable oxidization and reduction and reversibly switches between the forms of nitroxyl radical and oxoammonium cation.

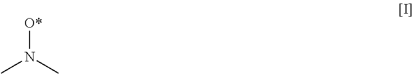

It is desirable that the molecular weight of the nitroxyl radical-bearing compound be less than 200, in particular, 140 to 160. It is desirable that the redox potential of the nitroxyl radical-bearing compound be 0.65 V (vs. Ag/Ag⁺ reference electrode). These redox reagents exert redox effects by existing in the electrolytic medium 22. The molar absorption coefficient ε can be determined from the absorbance of the electrolytic solution using the following equation (1) in accordance with the Lambert-Beer law.

$${log}_{10} ( \frac{{I}_{s}}{{I}_{0}} ) = - α L = - ed \qquad ( 1 )$$

It is desirable that the concentration of the redox reagent be in the range of 0.005 mol/L to 1 mol/L, more desirably 0.01 mol/L to 0.15 mol/L.

Examples of supporting electrolytes include tetrabutylammonium perchlorate, tetraethylammonium hexafluorophosphate, ammonium salts such as imidazolium salts and pyridinium salts, and alkali metal salts such as lithium perchlorate and potassium tetrafluoroborate.

It is desirable that the solvent be highly ion conductive. The solvent can be an aqueous or organic one, but organic solvents are desirable for higher stability of the solutes. Examples of organic solvents include carbonate compounds such as dimethyl carbonate, diethyl carbonate, methyl ethyl carbonate, ethylene carbonate, and propylene carbonate, ester compounds such as methyl acetate, methyl propionate, and γ-butyrolactone, ether compounds such as diethyl ether, 1,2-dimethoxyethane, 1,3-dioxolane, tetrahydrofuran, and 2-methyl-tetrahydrofuran, heterocyclic compounds such as 3-methyl-2-oxazolidinone and 2-methylpyrrolidone, nitrile compounds such as acetonitrile, methoxyacetonitrile, and propionitrile, and aprotic polar compounds such as sulfolane, dimethylsulfoxide, and dimethylformamide. Each of these solvents can be used alone, and it is also possible to use a mixture of two or more. In particular, carbonate compounds such as ethylene carbonate and propylene carbonate, heterocyclic compounds such as γ-butyrolactone, 3-methyl-2-oxazolidinone and 2-methylpyrrolidone, and nitrile compounds such as acetonitrile, methoxyacetonitrile, propionitrile, 3-methoxypropionitrile, and valeronitrile are desirable.

The solvent can also be an ionic liquid or a mixture of an ionic liquid and any of the solvents listed above. Ionic liquids are of low volatility and high flame retardancy.

Any known ionic liquid can be used, and examples include imidazolium-based ionic liquids such as 1-ethyl-3-methylimidazolium tetracyanoborate, pyridine-based, alicyclic amine-based, aliphatic amine-based, and azonium amine-based ionic liquids, and the ionic liquids mentioned in European Patent No. 718288, International Publication No. WO 95/18456, Electrochemistry Vol. 65, No. 11, page 923 (1997), J. Electrochem. Soc. Vol. 143, No. 10, page 3099 (1996), and Inorg. Chem. Vol. 35, page 1168 (1996).

### Dye Molecules

The dye can be any known material that is used as a sensitizing dye. Examples include 9-phenyl xanthene dyes, coumarin dyes, acridine dyes, triphenylmethane dyes, tetraphenylmethane dyes, quinone dyes, azo dyes, indigo dyes, cyanine dyes, merocyanine dyes, and xanthene dyes. Other materials can also be used, including ruthenium-cis-diaqua-bipyridyl complexes of a type of RuL₂(H₂O)₂ (where L represents 4,4′-dicarboxy-2,2′-bipyridine), transition metal complexes of types such as ruthenium-tris (RuL₃), ruthenium-bis (RuL₂), osmium-tris (OsL₃), and osmium-bis (OsL₂), zinc-tetra(4-carboxyphenyl)porphyrin, iron-hexacyanide complexes, and phthalocyanine. The dyes mentioned in a section about DSSC of a book in Japanese about “the cutting-edge technologies and material development concerning FPD, DSSC, optical memories, and functional dyes” (NTS Inc.) can also be used. In particular, associative dyes are desirable as they promote charge separation during photoelectric conversion. An example of a desirable effective dye that forms assemblies is a dye represented by the structure of chemical formula [II].

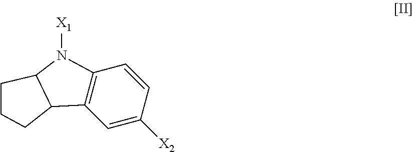

Various known methods can be used to make the dye molecules held on the semiconductor. An example of a method is to coat a substrate with a semiconductor layer (e.g., a porous semiconductor containing no dye molecules) and immerse this substrate in a solution in which the dye molecules are dissolved or dispersed. The solvent in this solution can be any appropriate solvent in which the dye molecules are soluble, such as water, an alcohol, toluene, or dimethylformamide. The substrate may be heated or sonicated while in the solution of the dye molecules. After immersion, the substrate may be washed with the solvent (e.g., an alcohol) and/or heated so that any excess of the dye molecules is removed.

The amount of dye molecules held on the semiconductor layer is, for example, in the range of 1×10⁻¹⁰ to 1×10⁻⁴ mol/cm², desirably 0.1×10⁻⁸ to 9.0×10⁻⁶ mol/cm² due to photoelectric conversion efficiency and cost considerations.

### Photoanode

The photoanode 15 serves as the anode of the photoelectric conversion element 100. As mentioned above, the photoanode 15 has, for example, an electroconductive layer 14 permeable to visible light and a semiconductor layer 16 on the electroconductive layer 14, and the semiconductor layer 16 contains dye molecules. The semiconductor layer 16 containing dye molecules may also be referred to as a light-absorbing layer. The substrate 12 in this situation is, for example, a glass or plastic substrate (or a plastic film) permeable to visible light.

The electroconductive layer 14 permeable to visible light can be made of, for example, a material permeable to visible light (hereinafter referred to as a “transparent electroconductive material”). Examples of transparent electroconductive materials include zinc oxide, indium-tin composite oxide, a laminate of an indium-tin composite oxide layer and a silver layer, antimony-doped tin oxide, and fluorine-doped tin oxide. In particular, fluorine-doped tin oxide is desirable because of its significantly high electroconductivity and light permeability. The higher optical transmissivity of the electroconductive layer 14, the better. It is desirable that the optical transmissivity of this layer be 50% or more, more desirably 80% or more.

The thickness of the electroconductive layer 14 is, for example, in the range of 0.1 μm to 10 μm. This allows an electroconductive layer 14 of uniform thickness to be formed with preserved optical transmissivity, thereby ensuring that a sufficient amount of light enters the semiconductor layer 16. The lower the surface resistance of the electroconductive layer 14, the better. It is desirable that the surface resistance of this layer be 200 Ω/sq. or less, more desirably 50 Ω/sq. or less. There is no particular lower limit, but an example of a lower limit is 0.1 Ω/sq. In general, photoelectric conversion elements for use under sunlight have an electroconductive layer with a sheet resistance of approximately 10 Ω/sq. The photoelectric conversion element 100, which is for use under light sources less illuminant than sunlight, such as fluorescent lamps, is less susceptible to the resistive components in the electroconductive layer 14 because of the smaller amount of photoelectrons (a lower photocurrent level). As a result, it is desirable that the electroconductive layer 14 in the photoelectric conversion element 100 for use under low-illuminance conditions have a surface resistance of 30 to 200 Ω/sq. so that the production costs can be reduced through the reduction of the amount of electroconductive materials in the electroconductive layer 14.

The electroconductive layer 14 permeable to visible light can also be made of an electroconductive material with no light permeability. For example, it is possible to use a metal layer in a pattern of stripes, waves, mesh, or punched metal (many fine holes opened regularly or irregularly through the metal layer) or a metal layer having a negative-positive inverted pattern. These metal layers allow light to pass through in portions where no metal exists. Examples of metals include platinum, gold, silver, copper, aluminum, rhodium, indium, titanium, iron, nickel, tin, zinc, and alloys containing any of these metals. It is also possible to use an electroconductive carbon material instead of metal.

The transmissivity of the electroconductive layer 14 permeable to visible light is, for example, 50% or more, desirably 80% or more. The wavelength of light that should permeate depends on the absorption wavelength of the dye molecules.

If light is allowed to enter the semiconductor layer 16 from the side opposite the substrate 12, the substrate 12 and the electroconductive layer 14 need not be permeable to visible light. In such an arrangement, therefore, the electroconductive layer 14 need not have a portion where no metal or carbon exists even if it is made of any of the metals mentioned above or carbon, and the electroconductive layer 14 can also serve as the substrate 12 if it is made of a sufficiently strong material.

Furthermore, there may be an oxide layer, such as a silicon oxide, tin oxide, titanium oxide, zirconium oxide, or aluminum oxide layer, between the electroconductive layer 14 and the semiconductor layer 16 to prevent electrons from leaking at the surface of the electroconductive layer 14, or in other words to rectify the electron flow between the electroconductive layer 14 and the semiconductor layer 16.

The photoelectric conversion element 100 according to the present embodiment, advantageously having a high open-circuit voltage V_{oc}, offers high efficiency in photoelectric conversion.

Furthermore, the photoelectric conversion element 100 according to the present embodiment is suitable for use under relatively low-illuminance conditions, such as the indoors. The wavelengths of light emitted from indoor or similar illuminators, such as fluorescent lamps, LEDs, and organic EL devices, are limited to a wavelength range near that of visible light, compared with those of sunlight. The redox reagent used in the photoelectric conversion element 100 according to the present embodiment has molar absorption coefficients as small as 3000 L·cm⁻¹·mol⁻¹ or less within wavelengths of 380 to 800 nm. The absorption of light by the redox reagent is therefore small, and the efficiency of this element in generating power from light emitted from indoor or similar illuminators is accordingly high.

### EXAMPLES

The following describes the present embodiment in more detail by providing some examples. Photoelectric conversion elements of Examples 1 to 15 and Comparative Examples 1 to 3 were prepared, and their characteristics were evaluated. The results of the evaluation are summarized in Table.

### Example 1

A photoelectric conversion element was produced having substantially the same structure as the photoelectric conversion element 100 illustrated in FIG. 1. The following components were used.
Substrate 12: A glass substrate, 1 mm in thickness
Transparent conductive layer 14: A fluorine-doped SnO₂ layer (a surface resistance of 10 Ω/sq.)
Semiconductor layer 16: Porous titanium oxide and dye molecules (D358, Mitsubishi Paper Mills; chemical formula [III])

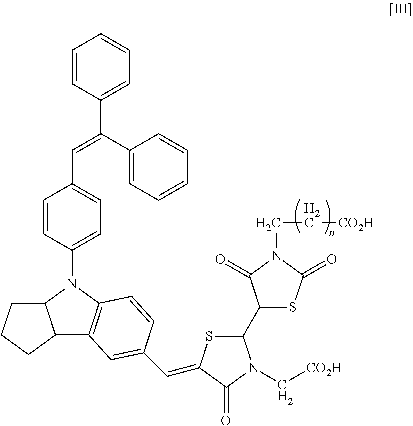

Electrolytic medium 22: A solution of 0.03 mol/L of TEMPO as a redox reagent and 0.1 mol/L of LiTFSI (lithium bis(trifluoromethanesulfonyl)imide) as a supporting electrolyte in GBL (γ-butyrolactone)
Substrate 32: A glass substrate, 1 mm in thickness
Electroconductive oxide layer 34: A fluorine-doped SnO₂ layer (a surface resistance of 10 Ω/sq.)
Metal layer 36: A platinum layer

The photoelectric conversion element of Example 1 was prepared as follows.

Two 1-mm thick electroconductive glass substrates having a fluorine-doped SnO₂ layer (Asahi Glass) were prepared. These substrates were used as the substrate 12 having the transparent electroconductive layer 14 and the substrate 32 having the electroconductive oxide layer 34.

A high-purity titanium oxide powder having an arithmetic mean primary particle diameter of 20 nm was dispersed in ethyl cellulose to form a paste for screen printing.

A titanium oxide layer having a thickness of approximately 10 nm was formed through sputtering on the fluorine-doped SnO₂ layer of one electroconductive glass substrate, and the above paste was applied to the titanium oxide layer and dried. The obtained dry material was fired at 500° C. for 30 minutes in the air to form a porous titanium oxide layer (titanium coating) having a thickness of 1.0 μm as a low-light-scattering layer 16a.

One gram of the high-purity titanium oxide powder having an arithmetic mean primary particle diameter of 20 nm was mixed with 4 g of water, 8 g of ethanol, and 1 g of HO—(C₂H₄O)₁₀₆—(C₃H₆O)₇₀—(C₂H₄O)₁₀₆—H as a block copolymer, and 1 g of water-insoluble polymer particles having an arithmetic mean diameter of 2.5 μm (SSX-102, Sekisui Plastics). The mixture was stirred and sonicated to form a homogenous liquid dispersion as a liquid dispersion for the formation of a porous electrode.

The prepared liquid dispersion for the formation of a porous electrode was applied using spin coating (500 rpm, 20 seconds) to the electroconductive glass substrate on which the low-light-scattering layer 16a had been formed. The spin-coated electroconductive glass substrate was dried and fired at 500° C. for 1 hour in the air to form a light-scattering layer 16s.

FIG. 2 illustrates a cross-sectional scanning electron microscopic (SEM) image of the electroconductive glass substrate with the light-scattering layer 16s after a round of spin coating. The observation demonstrated that a low-light-scattering layer 16a and a light-scattering layer 16s having macropores were formed on the electroconductive glass substrate. Macropores were formed in the light-scattering layer 16s made up of nanoparticles of titanium oxide. The macropores were formed by the disappearance of water-insoluble spherical polymer particles having an arithmetic mean diameter of 2.5 μm. The image therefore indicated that the intended structure, i.e., a scattering layer having macropores, was successfully formed. The surface of the light-scattering layer 16s, furthermore, was found to have an uneven shape following the shape of the spherical polymer particles.

On the surface of the light-scattering layer 16s, some macropores were observed to have an opening to the outside. In other word, particles which formed a shell of the macropore had an opening to the outside. The cross-sectional observation also revealed that some macropores were connected with one another. This structure obtained in the present example should be because the light-scattering layer 16s was formed using the production method described above.

Note that the light-scattering layer 16s was obtained through multiple rounds of application and drying of the liquid dispersion for the formation of a porous electrode so that an intended thickness of the light-scattering layer 16s would be reached.

The substrate with the semiconductor layer (porous titanium oxide layer) 16 was then immersed in a solution of 0.3 mmol/L of the aforementioned dye molecules (chemical formula [III]) in a 1:1 mixture of acetonitrile and butanol. The substrate in the solution was then left in the dark at room temperature for 16 hours until the dye molecules were held on the porous titanium oxide layer. In this way, a photoanode was formed.

Then a counter electrode was formed through the deposition of a layer of platinum on the surface of the other glass substrate using sputtering.

A heat-melt adhesive agent (Du Pont-Mitsui Polychemicals) as a sealant was applied to the peripheral region of each of the two glass substrates. The sealant was disposed to surround each of the porous titanium oxide layer and the counter electrode. Then, the two glass substrates were placed to face each other and joined together through thermal compression. An opening was made in the glass substrate bearing the counter electrode beforehand using a drill with a diamond bit.

An electrolytic solution of 0.03 mol/L TEMPO and 0.1 mol/L LiTFSI in GBL (γ-butyrolactone) was then injected through the opening under reduced pressure so that a sufficient quantity of the electrolytic solution would penetrate into the semiconductor layer. In this way, the photoelectric conversion element of Example 1 was obtained.

This photoelectric conversion element was irradiated with light at an illuminance of 200 lx emitted by a self-ballasted fluorescent lamp, and the conversion efficiency was determined through the measurement of the current-voltage characteristics. This condition of measurement is approximately 1/500 of an illuminance of sunlight, but naturally, the uses include conditions under sunlight and are not limited to this. The results are summarized in Table.

In Table, the size of macropores in the light-scattering layer 16s is a peak value based on the pore distribution in a separately prepared light-scattering layer 16s measured with mercury intrusion and is substantially equal to an arithmetic mean. The porosity of the light-scattering layer 16s is a calculated percentage of the void volume to the total volume of the light-scattering layer 16s, where the void volume is the total volume of 10 μm or smaller pores measured using mercury intrusion (AutoPore IV 9500, Shimadzu). The molar absorption coefficient of the redox reagent was determined from a measured absorbance of the electrolytic solution (UV-3150 UV-Vis-NIR spectrophotometer, Shimadzu) using equation (1).

### Examples 2 to 15 and Comparative Examples 1 to 3

The thickness of the low-light-scattering layer 16a, the size of macropores in the light-scattering layer 16s, the porosity of the light-scattering layer 16s, the thickness of the light-scattering layer 16s, and the redox reagent in Example 1 were changed as specified in Table.

In Example 7, the quantity of water-insoluble polymer particles in the liquid dispersion for the formation of a porous electrode was half that in Example 1. In Example 8, the quantity of water-insoluble polymer particles in the liquid dispersion for the formation of a porous electrode was double that in Example 1. In Comparative Example 1, the quantity of water-insoluble polymer particles in the liquid dispersion for the formation of a porous electrode was 0.1 times that in Example 1.

Like that in Example 1, the light-scattering layers 16s in Examples 2 to 15 and Comparative Example 1 were obtained through as many rounds of application and drying of the liquid dispersion for the formation of a porous electrode as needed to reach their intended thickness.

In Comparative Examples 2 and 3, the light-scattering layer 16s was composed of particles of titanium oxide having an arithmetic mean diameter of 0.4 μm. A high-purity titanium oxide powder having an arithmetic mean diameter of 0.4 μm was dispersed in ethyl cellulose to form a paste for screen printing, and this paste was applied and dried. The obtained dry material was fired at 500° C. for 30 minutes in the air to form a light-scattering layer 16s.

The chemical formulae and abbreviations of the redox reagents are as follows.

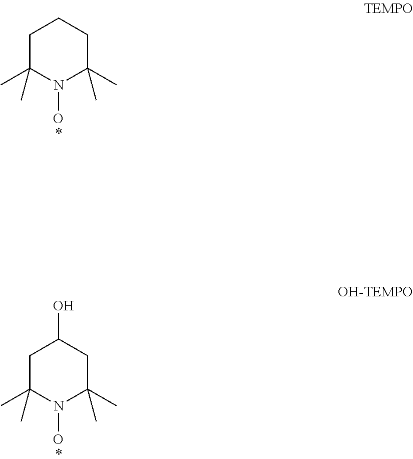

Photoelectric conversion elements were produced using the same process as in Example 1 except for the foregoing. The results of evaluation are summarized in Table.

TABLE

| | | | | | | Maximum | |
|---|---|---|---|---|---|---|---|
| | | | | | | molar | |
| | | | | | | absorption | |
| | | | | | | coefficient of | |
| | | | | | | redox | |
| | | | | | | reagent | |
| | Thickness | Size of | | | | within | |
| | of low- | macropores | Porosity | Thickness | | wavelengths | |
| | light- | in light- | of light- | of light- | | 380 nm to | Conversion |
| | scattering | scattering | scattering | scattering | Redox | 800 nm | efficiency at |
| | layer | layer | layer | layer | reagent | (L · cm⁻¹ · mol⁻¹) | 200 lx |
| Example 1 | 0.9 μm | 0.5 μm | 80% | 6.5 μm | TEMPO | 10 | 13.4% |
| Example 2 | 0.9 μm | 2.1 μm | 83% | 4.3 μm | TEMPO | 10 | 15.4% |
| Example 3 | 0.9 μm | 4.0 μm | 84% | 4.3 μm | TEMPO | 10 | 14.6% |
| Example 4 | 0.9 μm | 7.8 μm | 84% | 14.3 μm | TEMPO | 10 | 13.0% |
| Example 5 | 0.9 μm | 2.1 μm | 83% | 11 μm | TEMPO | 10 | 14.8% |
| Example 6 | 0.7 μm | 2.1 μm | 83% | 4.3 μm | TEMPO | 10 | 14.3% |
| Example 7 | 0.9 μm | 2.1 μm | 72% | 3.4 μm | TEMPO | 10 | 13.5% |
| Example 8 | 0.9 μm | 2.1 μm | 91% | 4.9 μm | TEMPO | 10 | 13.7% |
| Example 9 | 0.9 μm | 2.1 μm | 83% | 4.3 μm | OH- | 13 | 10.5% |
| | | | | | TEMPO | | |
| Example 10 | None | 2.1 μm | 83% | 4.3 μm | TEMPO | 10 | 11.4% |
| Example 11 | 0.9 μm | 0.3 μm | 79% | 6.2 μm | TEMPO | 10 | 9.6% |
| Example 12 | 0.9 μm | 12 μm | 85% | 20 μm | TEMPO | 10 | 7.9% |
| Example 13 | 0.9 μm | 2.1 μm | 83% | 18 μm | TEMPO | 10 | 9.3% |
| Example 14 | 2.0 μm | 2.1 μm | 83% | 4.3 μm | TEMPO | 10 | 12.2% |
| Example 15 | 0.9 μm | 2.1 μm | 60% | 4.0 μm | TEMPO | 10 | 10.0% |
| Comparative | 0.9 μm | 2.1 μm | 83% | 4.3 μm | Lil | 6330 | 5.8% |
| Example 1 | | | | | | | |

| | | | | | | |
|---|---|---|---|---|---|---|
| Comparative | 0.9 μm | (0.4-μm titanium | 4.3 μm | Lil | 6330 | 9.5% |
| Example 2 | | oxide particles) | | | | |
| Comparative | None | (0.4-μm titanium | 4.3 μm | Lil | 6330 | 8.0% |
| Example 3 | | oxide particles) | | | | |

Comparing Examples 2 and 9 with Comparative Example 1 reveals that with any of TEMPO and OH-TEMPO, which are redox reagents having a maximum molar absorption coefficient of 3000 L·cm⁻¹·mol⁻¹ or less within wavelengths of 380 nm to 800 nm, the conversion efficiency is higher than with LiI, which has a molar absorption coefficient exceeding 3000 L·cm⁻¹·mol⁻¹ within wavelengths 380 nm to 800 nm.

A comparison of Examples 2 and 10 with Comparative Examples 2 and 3 indicates that the use of a light-scattering layer 16s having macropores and TEMPO, which has a maximum molar absorption coefficient of 3000 L·cm⁻¹·mol⁻¹ or less within wavelengths of 380 nm to 800 nm, leads to higher conversion efficiency than with a light-scattering layer 16s composed of titanium oxide particles having an arithmetic mean diameter of 0.4 μm and LiI, which has a maximum molar absorption coefficient exceeding 3000 L·cm⁻¹·mol⁻¹ within wavelengths 380 nm to 800 nm.

As can be seen from a comparison of Examples 1 to 4 with Examples 11 and 12, furthermore, the conversion efficiency is high when the size of macropores in the light-scattering layer 16s is 0.5 μm or more and 10 μm or less.

A comparison of Examples 2 and 5 with Example 13 reveals that the conversion efficiency is high when the light-scattering layer 16s has a thickness of 3 μm or more and 15 μm or less. Comparing Examples 2, 6, and 10 with Example 14 indicates that the use of a low-light-scattering layer 16a thinner than 2 μm results in high conversion efficiency.

Comparing Examples 2, 7, and 8 with Example 15, furthermore, demonstrates that a porosity of the light-scattering layer 16s of more than 60% leads to high conversion efficiency.

In addition, the openings of macropores on the surface of the light-scattering layer and connections between macropores mentioned in Example 1 increased in number with increasing proportion of the water-insoluble polymer particles to the titanium oxide powder. This is presumably because increasing the proportion of the water-insoluble polymer particles makes it more likely that the water-insoluble polymer particles before firing are exposed on the surface of the applied layer or come into direct contact with one another.

Photoelectric conversion elements according to the present disclosure can be used as, for example, dye-sensitized power generation elements capable of generating power even under relatively low-illuminance conditions, such as the indoors.

What is claimed is:

1. A photoelectric conversion element, comprising:
a photoanode including a porous semiconductor layer and dye molecules located on the porous semiconductor layer, the porous semiconductor layer including a light-scattering layer;
a counter electrode; and
an electrolytic medium located between the photoanode and the counter electrode, the electrolytic medium containing a redox reagent, wherein:
the light-scattering layer has macropores having a pore diameter of 50 nm or more, the macropores having an arithmetic mean pore diameter of 0.5 μm or more and 10 μm or less; and
the redox reagent has a maximum molar absorption coefficient ε of 3000 L·cm⁻¹·mol⁻¹ or less within wavelengths of 380 nm to 800 nm.

2. The photoelectric conversion element according to claim 1, wherein
a part of the electrolytic medium is present in the macropores.

3. The photoelectric conversion element according to claim 1, wherein
at least two of the macropores are connected to each other.

4. The photoelectric conversion element according to claim 1, wherein
at least one of the macropores has an opening in a surface of the light-scattering layer.

5. The photoelectric conversion element according to claim 1, wherein
the light-scattering layer has a thickness of 3 μm or more and 15 μm or less.

6. The photoelectric conversion element according to claim 1, wherein:
the porous semiconductor layer further includes a low-light-scattering layer located on a light incident side of the light-scattering layer, the low-light-scattering layer scattering light less than the light-scattering layer does or not scattering light; and
the low-light-scattering layer has a thickness of less than 1.5 μm.

7. The photoelectric conversion element according to claim 1, wherein
the redox reagent includes a nitroxyl radical-bearing compound.

8. The photoelectric conversion element according to claim 7, wherein
the nitroxyl radical-bearing compound is 4-hydroxy-2,2,6,6-tetramethylpiperidine-1-oxyl.
